(19) United States
(12) Patent Application Publication
(10) Pub. No.: US 2006/0188659 A1
(43) Pub. Date: Aug. 24, 2006

(54) Cobalt self-initiated electroless via fill for stacked memory cells

(75) Inventors: Qingyun Chen, Branford, CT (US); Richard Hurtubise, Clinton, CT (US); Christian Witt, Woodbridge, CT (US); Joseph A. Abys, Warren, NJ (US); Daniel Stritch, Dunbury, CT (US); Charles Valverde, Ansonia, CT (US)

Correspondence Address: SENNIGER POWERS, ONE METROPOLITAN SQUARE, 16TH FLOOR, ST LOUIS, MO, 63102, US

(73) Assignee: Enthone Inc., West Haven, CT (US)

(21) Appl. No.: 11/063,624

(22) Filed: Feb. 23, 2005

(51) Int. Cl. B05D 1/18

(52) U.S. Cl. 427/437; 427/443.1

(57) ABSTRACT

A method for electrolessly filling a stacked memory cell interconnect feature comprising electroless deposition from a composition comprising Co ions and a reducing agent by bottom-up filling initiated by reduction to Co metal on an electrically conducting bottom of the feature. An electroless deposition composition for electrolessly depositing Co in a high aspect ratio stacked memory cell interconnect feature, the composition comprising water, Co ions, a complexing agent, a buffering agent, a borane-based reducing agent component, and a hypophosphite reducing agent component. There is a concentration ratio of borane-based reducing agent to hypophosphite reducing agent of less than about 0.5.

### FIELD OF THE INVENTION

This invention relates to stacked memory cell manufacture and, in particular, to metal-based filling of interconnect features of stacked memory cells such as vias, trenches, contact openings, and through-holes.

### BACKGROUND OF THE INVENTION

Memory circuits such as dynamic random access memory (DRAM) devices are generally composed of memory cells where data are stored. Data are stored in capacitors, which hold data as an electrical charge. Memory cells are typically arranged in an array.

DRAM devices typically come in two types, trenched capacitor type and stacked capacitor type. Trench type cells are manufactured by forming the capacitor in the side wall of a trench formed in a semiconductor substrate. Stacked capacitor type cells, on the other hand, are manufactured by stacking electrode layers above the substrate to form the capacitor. Stacked capacitors stand high to achieve sufficient storage of charge. As device geometries miniaturize, contact aspect ratios, i.e., the ratio of via contact depth to via contact diameter, have increased as a result of increasing stacked capacitor height. Stacked capacitor cells are also known to those skilled in the art as stacked memory cells or devices.

Stacked memory applications typically do not require the level of electrical conductivity of logic operations, i.e., integrated circuits. Therefore, less electrically conductive plug metallization may be used for filling stacked memory vias instead of a more conductive material, such as Cu. Tungsten is an exemplary plug metallization because its electrical conductivity, while not as great as that of Cu, is sufficient for memory applications. Further, because of its refractory nature, W does not diffuse into the Si wafer or low k dielectric layer. Therefore, a diffusion-preventing barrier layer between the Si or dielectric material and the W metallization is not necessary.

Tungsten metal-filling into vias and trenches has been achieved by chemical vapor deposition (CVD) or physical vapor deposition (PVD). In general, metal filling by blanket vapor deposition is expensive and time-consuming, as it involves multiple processing steps. The metal deposited overburdens the interconnect feature and therefore needs to be patterned and etched, followed by resist removal. Some degree of misalignment is expected with lithographic patterning. Further, vapor deposition may fill metal into and pinch off the top of a high aspect ratio via or trench, resulting in voids within the stacked memory interconnect.

Removal of overburden may occur by chemical mechanical polishing (CMP). CMP is performed on a substrate following via formation to, for example, remove unwanted W overburden deposited during the deposition process and thereby planarize the surface. This CMP can cause traces of W to be embedded or smeared onto the dielectric material. These traces of W, if not removed, can contaminate the dielectric. An etchant is therefore employed in a pretreatment composition to either remove these traces of W, undercut the dielectric on which they reside, or both.

The use of Co as a plug metallization in stacked memory devices is an attractive alternative to the use of W. In stacked memory applications, Co performs better electrically than W. Also, Co is of a sufficient refractory nature to impede diffusion into the dielectric layer. Cobalt can be applied by methods other than CVD.

Catalyst-initiated electroless Co deposition has been discussed in, for example, U.S. Pat. No. 6,232,227. Metallization of high aspect ratio interconnect features by catalyst-initiated electroless Co deposition is disadvantageous in that Co begins to grow on every surface which contains the catalyst. Catalyst seeding, such as in palladium seeding, occurs non-selectively with respect to the Si or dielectric surface. Therefore, Pd seeds will occur on the bottom of the interconnect feature, as well as the side walls and the wafer surface. Application of the metal onto the diffusion layer surface located at the bottom of the via is difficult to achieve without collateral application of the metal to the side walls of the via and to the wafer surface. Thus, immersion of the wafer substrate into a Co solution results in growth of Co on the side walls of the via and on the wafer surface. This results in two disadvantages. First, Co must be removed from the surface of the device by a subsequent planarization or etching step. Second, Co growth on the side walls of the via can result in a pinching shut of the via, thereby creating voids in the interconnect structure.

Therefore, a process is needed which can fill high aspect ratio interconnect features in a stacked capacitor device which does not cause metallization to pinch off the feature opening and result in voids within the interconnect feature. Further, a process and composition are needed to selectively deposit Co metallization onto the bottom of a high aspect interconnect feature in a stacked capacitor device and fill in the feature from the bottom to the top, without collateral growth on the sides of the interconnect, or on surface of the device. Finally, a composition is needed which auto-catalyzes the deposition of conductive Co and Co alloys onto a source/drain region of a high aspect interconnect feature in a stacked memory device.

### SUMMARY OF THE INVENTION

Briefly, therefore, the invention is directed a method for electrolessly filling a stacked memory cell interconnect feature, the method comprising contacting the stacked memory cell interconnect-feature with an electroless deposition composition comprising a source of Co ions and a reducing agent, wherein the stacked memory interconnect feature has an electrically conducting bottom and a height-to-width aspect ratio of at least about 2, whereby a portion of the Co ions are reduced to Co metal on the electrically conducting bottom, and bottom-up filling of the stacked memory interconnect feature is achieved by continued reduction of Co ions.

In another aspect, the invention is directed to an electroless deposition composition for electrolessly depositing Co in a high aspect ratio stacked memory cell interconnect feature. The composition comprises water, a source of Co ions, a complexing agent, a buffering agent, a borane-based reducing agent component, and a hypophosphite reducing agent component. The borane-based reducing agent component is selected from the group consisting of an alkali metal borohydride, dimethylamine borane, diethylamine borane, morpholine borane, and mixtures thereof. The hypophosphite reducing agent component is selected from the group consisting of an alkali metal hypophosphite, ammonium hypophosphite, hypophosphorous acid, and mixtures thereof. The borane-based reducing agent component concentration and the hypophosphite reducing agent component concentration are selected to yield a concentration ratio of borane-based reducing agent component concentration in g/L to hypophosphite reducing agent component concentration in g/L which is less than about 0.5.

### BRIEF DESCRIPTION OF THE FIGURE

FIG. 1 is a schematic representation of a segment of a stacked memory cell.

FIG. 2 is a photomicrograph of test vias filled in accordance with the invention.

### DETAILED DESCRIPTION OF PREFERRED EMBODIMENTS

According to the present invention, metallization is filled into an interconnect feature in a stacked memory device; for example, Co or an alloy thereof is filled into a high aspect ratio via or trench of a stacked memory cell. The interconnect feature includes a bottom, side walls, and a top opening. The height of the sides walls and diameter of the opening are such that the via has a high aspect ratio. As a general proposition, the ratio of the height of the walls to the diameter of the opening is greater than 5. In another embodiment, the aspect ratio is at least 10. In one such embodiment of the invention, the aspect ratio is at least about 18.

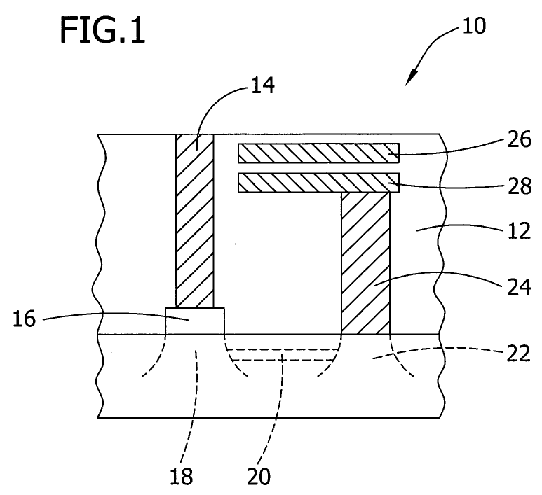

FIG. 1 is a schematic drawing of a segment of a stacked memory cell of the type having a via formed in accordance with the invention. In the stacked memory cell segment 10 shown here in cross section, there is dielectric material 12 which is a standard dielectric material such as SiO₂, fluorinated silicate glass, BPSG, or other low k dielectric. Via 14 provides electrical connectivity between the top of the device segment and the source area 18. Contact 16 between the via 14 and source area 18 is made, for example, of W, layered W—WN, or layered WSi₂-polysilicon. Transistor gate 20 provides electrical connectivity between source area 18 and drain 22. Source area 18 and drain area 22 are within a body of semiconductor single crystal Si and comprise semiconductor single crystal Si doped with, for example, P, As, or other standard dopant materials. Via 24 provides electrical connectivity to a capacitor generally comprising plates 26 and 28 comprising a metal such as Cu or Al separated by dielectric as shown schematically.

The bottom of via 14 is electrically conductive material in that it is a contact of, for example, W, layered W—WN, or layered WSi₂-polysilicon. The bottom of via 24 is electrically conductive material in that it is a drain of, for example, doped Si. In other embodiments, the device drain is composed of TiN or Ru. The metal for filling the interconnect is Co-based, such as Co metal, or an alloy thereof, including, but not limited to Co—B—P, Co—W—B—P, Co—W—B, and Co—B. The electrically conductive material at the bottom of the vias 14 and 24 provides conductivity as required for bottom-up, electroless, self-initiated superfilling in accordance with the invention as described hereinbelow.

The interconnect filling involves initiation of deposition on the bottom of the interconnect, and then bottom-up filling from the bottom to the top of the interconnect. The filling is “bottom up” in that it occurs primarily in the direction from the bottom of the interconnect to the top, and there is no substantial side wall deposition. Filling is initiated by depositing the Co-based material by a borane-chemistry electroless deposition process employing an alkylamine borane compound such as dimethylamine borane (DMAB), diethylamine borane (DEAB), or morpholine borane as a reducing agent. These borane-based reducing agents render W catalytic to Co deposition. The process is therefore self-initiating on the W via bottom, so Co, Pd, or other seeding operation is excluded. This is in contrast to electroless processes based on non-borane chemistry, such as employing hypophosphite or other non-borane reducing agents, which do not render W catalytic to Co deposition. The non-borane processes, if used to deposit Co directly on a W via, require Co seeding or another activation mechanism. Other materials which are rendered catalytic by borane chemistry include Cu, Co, Pt, Mo, Au, and Pd, however, Au is preferably rendered catalytic with hydrazine.

A substantial advantage of selection of the foregoing materials is that Co-based growth is initiated from the bottom of the via. In performing the method of the invention, metallization fills from the bottom of the interconnect feature upwardly toward the opening. This filling method avoids both problems of collateral side deposition, which may pinch closed the opening of the via, and of surface deposition, which requires a planarization step, such as CMP.

Electroless plating baths for electroless plating of Co and alloys thereof in accordance with this invention comprise a source of deposition ions, a reducing agent, a complexing agent, and a surfactant. The bath is buffered within a certain pH range. Optionally, the bath may also comprise surfactants, a source of refractory ions, and stabilizers. The bath is formulated such that it self initiates onto the drain substrate material, such as W. Baths which self-initiate onto Cu substrates such as in capping applications may or may not self initiate Co deposition onto W. The baths also differ from Co capping applications in that it is critical to deposit an alloy with good conductivity—typically high Co, because the interconnect is intended to carry current; which is in contrast to Co deposition in capping applications.

For the deposition of a Co-based alloy, the bath comprises a source of Co ions, which are introduced into the solution as an inorganic Co salt such as chloride, sulfate, or other suitable inorganic salt, or a Co complex with an organic carboxylic acid such as Co acetate, citrate, lactate, succinate, propionate, hydroxyacetate, EDTA or others.

In one embodiment, the inorganic Co salt is Co(OH)₂. The hydroxyl group has a lower molecular weight than the other anions in typical Co salts. The Co(OH)₂ salt results in a simpler plating bath because hydroxyl ions are already present in an aqueous solution. Therefore, no additional anions, such as the halides, are introduced into the electroless bath, so the risk of contamination by such anions is avoided.

In one embodiment, the Co salt or complex is added to provide about 0.5 g/L to about 60 g/L of Co²⁺ to yield a Co-based alloy of high Co metal content.

A reducing agent is employed which is a borane-based reducing agent component alone or in combination with a hypophosphite reducing agent component. In CoB systems, where a borane-based reducing agent is used alone, the Co alloy has a higher Co content. However, when a combination of reducing agents is used, both the bath stability and the filling of the via or trench feature is improved. The reducing agent is discussed more fully below.

The bath further contains one or more complexing agents and buffering agents. The bath typically contains a pH buffer to stabilize the pH in the desired range. In one embodiment, the desired pH range is between about 7.5 and about 10.0. In one embodiment, it is between about 8.8 and about 10. These pH ranges provide a mildly alkaline electroplating bath. If the pH is not stabilized, unintentional, undesirable, and unanticipated changes in deposition rate and deposit chemistry can occur. Exemplary buffers include, for example, borates, tetra- and pentaborates, phosphates, acetates, glycolates, lactates, ammonia, and pyrophosphate. For basic pH adjustment, ammonium, TMAH, NaOH, KOH, or mixtures thereof are employed. Sulfuric, hydrochloric, and citric acids are used for acidic pH adjustment, with the acid selection made to correlate to the anion of the Co source. In one embodiment, the pH buffer level is on the order of between about 0 g/L and about 50 g/L.

A complexing agent is included in the bath to help keep the Co ions in solution and modify the plating potential of the bath needed for initiation of deposition. The complexing agents used in the bath are selected from among citric acid, malic acid, ethylenediamine, glycine, propionic, succinic, and lactic acids, diethylamine (DEA), tetraethylamine hydroxide (TEAH), and ammonium salts such as ammonium chloride, ammonium sulfate, ammonium hydroxide, pyrophosphate, and mixtures thereof. In one embodiment, the complexing agent concentration is selected such that the molar ratio between the complexing agent and Co is between about 2:1 and about 4:1, generally. In another embodiment, the ratio is about 9:1 to about 10:1. Depending on the complexing agent molecular weight, the level of complexing agent may be on the order of between about 5 g/L and about 250 g/L.

Surfactants may be added to promote wetting of the metal interconnect surface and enhance the deposition. The surfactant serves to reduce defects by enhancing a uniform and dense interconnect fill, thereby improving morphology and topography of the deposit. It can also help refine the grain size, which also yields a more uniform deposit. Exemplary anionic surfactants include alkyl phosphonates, alkyl ether phosphates, alkyl sulfates, alkyl ether sulfates, alkyl sulfonates, alkyl ether sulfonates, carboxylic acid ethers, carboxylic acid esters, alkyl aryl sulfonates, and sulfosuccinates. Exemplary non-ionic surfactants include alkoxylated alcohols, ethoxy/propoxy (EO/PO) block copolymers, alkoxylated fatty acids, glycol and glycerol esters, with polyethylene glycols, and polypropylene glycol/polyethylene glycol currently preferred. In one embodiment, the level of surfactant is on the order of between about 0.01 g/L and about 5 g/L.

If desired, the plating bath may also include a refractory metal ion, such as tungsten and/or molybdenum. Exemplary sources of W ions are tetramethylammonium tungstate, phosphotungstate, silicotungstate, tungstic acid, tungsten oxide, and mixtures thereof. For example, one preferred deposition bath contains between about 1 g/L and about 15 g/L of tungstic acid. Other sources of refractory metal include ammonium molybdate and/or molybdenum oxide. In one embodiment, the source of refractory ions is substantially free of alkali metals, which, if present, could contaminate the deposit.

A stabilizer may be incorporated into the electroless Co deposition bath. The use of a stabilizer can help prevent spontaneous decomposition of the bath. Exemplary stabilizers include, for example, Pb, Bi, Sn, Sb, IO₃, MoO₃, AsO₃, azoles such as imidazole and derivatives. The stabilizer level is on the order of between about 0 and about 500 ppm. For example, for Pb⁺² from about 5 to about 20 ppm has been shown to be effective. For MoO₄⁻², about 10 to about 300 ppm has been shown to be effective. Maleic acid is particularly advantageous in some applications because it does not add additional metal ions into the deposition bath, which could contaminate the deposit.

Other additives, as are conventionally known in the art such as rate promoters and brighteners may also be added. In some embodiments, especially for semiconductor applications, the bath is substantially free of Na and other alkali metal ions.

The reducing agent contains a borane-based component such as an alkali metal borohydride, dimethylamine borane (DMAB), diethylamine borane (DEAB), and morpholine borane. Elemental boron from the borane-based reducing agent component becomes part of the plated alloy. A reaction mechanism explaining this phenomenon with respect to borohydride is shown:
2Co²⁺+2BH₄⁻+4H₂O=2Co⁰+B⁰+3B(OH)₄⁻+3H⁺+(9/2)H₂

According to the reaction mechanism, the plating solution requires 2 moles of BH₄⁻ to reduce 2 moles of Co²⁺ into the Co alloy. To ensure that a sufficient concentration of reducing agent is present in the plating bath, in one embodiment, dimethylamine borane is added in an initial concentration of about 0.5 g/L to about 16 g/L, for example about 3 g/L. One preferred embodiment employs between about 3 g/L and about 9 g/L of DMAB.

In one embodiment of the invention, the reducing agent also includes a phosphorus-based reducing agent component, such as hypophosphite. When hypophosphite is included, the deposited alloy contains phosphorus. The reaction mechanism proposed to explain this phenomenon is shown:
Co²⁺+4H₂PO₂⁻+H₂O=Co⁰+3H₂PO₃⁻+H⁺+P⁰+(3/2)H₂

According to the reaction mechanism, the plating solution requires four moles of H₂PO₂⁻ to reduce 1 mole of Co²⁺ into the Co alloy. The molar ratio of Co ions to hypophosphite ions in the plating solution is selected to be between about 0.1 and about 1. To ensure that a sufficient concentration of hypophosphite is present in the plating bath, in one embodiment, the hypophosphite salt, which may be an alkali metal hypophosphite, ammonium hypophosphite, or hypophosphorous acid is added in an initial concentration of about 20 g/L to about 30 g/L. In one embodiment, about 23 g/L to about 26 g/L of ammonium hypophosphite is added.

Hypophosphite reduces Co ions spontaneously only upon a limited number of substrates, including: Co, Ni, Rh, Pd, and Pt. Not included in this list is W, a particular metal of interest for its use as a drain/source in high aspect ratio interconnect features in stacked memory cells. For hypophosphite reduction of Co ions over a W substrate, the W surface may be activated by PVD or CVD Cu or Co, or Pd seeding. According to the present invention, the W surface is treated with a strong reducing agent, such as DMAB, to activate the surface for hypophosphite reduction.

In the embodiment of the invention with both borane-based and hypophosphite components in the reducing agent, a concentration ratio of a concentration of the borane-based reducing agent in grams/liter to a concentration of the hypophosphite reducing agent in grams/liter is less than about 0.5 at initial contact of the interconnect feature with the electroless deposition bath. In one embodiment, the concentration ratio is less than about 0.2 at initial contact of the interconnect feature with the electroless deposition bath. The ratio is chosen to affect the initiation and growth rate, the plating potential, and the properties of the plated alloy. For example, the ratio is chosen such that Co deposition occurs auto-catalytically on the surface of the source/drain in a stacked memory device. Moreover, because conductivity is a desired characteristic of the Co plug, the ratio of reducing agents is chosen to minimize to co-deposition of B or P. In one embodiment, a reducing agent system employs about 9 g/L DMAB reducing agent in a mixture with about 23 g/L hypophosphite reducing agent. The borane-based reducing agent initiates electroless deposition of Co²⁺ ions into Co metal onto the W or other metal-based drain surface. After initiation redox chemistry occurs, both reducing agents proceed to reduce Co²⁺ ions onto the Co surface to fill in a high aspect ratio feature of the stacked memory device.

In performing the method of the invention, surface pretreatment is performed which employs an organic or inorganic acid or basic cleaner for removing tungsten oxides from the metal interconnect feature. This cleaner preferably removes all the oxide, for example tungsten oxide, without removing substantial amounts of the metallization in the interconnects. Unless removed, the oxides can interfere with not only initiation but also adhesion of the metallization to the substrate and can detract from electrical conductivity. Cleaners of this type typically contain an etching agent such as a weak solution of an acid with less than 10 wt % in water of a strong mineral acid such as HF, HNO₃, or H₂SO₄ or a weak organic or carboxylic acid such as citric or malonic acid. Such cleaners also include a surfactant to help wet the surface, such as Rhodafac RE620 (Rhone-Poulenc).

Typical basic cleaners contain TMAH with addition of hydroxylamine, MEA, TEAH, EDA (ethylenediamine), DTA (diethylenetriamine), or NH₄OH at pH range of 9 to 12. Basic cleaning is preferred as it does not etch the side wall and cleans the oxides effectively.

On a fresh W surface, the pretreatment step is optional because the bath solution can clean the thin tungsten oxide layer at the working pH. Optionally, cationic organic compounds may be added to the pretreatment solution to protect the side wall from etching during the plating process.

As noted above, deposition of a Co-based interconnect is performed by electroless deposition employing borane chemistry. This exposure may comprise dip, flood immersion, spray, or other manner of exposing the stacked memory cell to a deposition bath, with the provision that the manner of exposure adequately achieve the objectives of depositing Co-based metallization of the desired depth and integrity into an interconnect.

Self-initiating electroless Co deposition is achieved when the borane-based reducing agent contacts the conducting surface. In particular, at certain deposition conditions, e.g. pH and temperature, the borane-based reducing agents are oxidized at the catalytic W surface, or doped Si surface as the case may be, thereby releasing electrons onto the surface. The released electrons subsequently are taken up by the Co²⁺ ions thereby reducing the Co²⁺ ions to Co metal.

This initial oxidation/reduction reaction can only be achieved at a sufficiently conducting surface such as the W surface at the via bottom. Substrates other than W may be dictated by factors germane to the device or to the drain itself which are not specifically germane to the via filling process of the invention, which substrates are nonetheless compatible therewith. Provided the drain material is at least as noble as W, the invention is applicable. The Co-based deposit does not initiate on the via side walls as the side walls are composed of a dielectric material; rather, the deposit is only initiated at the via bottom. Once an initial Co deposit is formed on the via bottom, the hypophosphite reducing agent and borane-based reducing agent interact with the Co deposit, thereby releasing electrons for further reduction of Co²⁺ ions to Co metal. This oxidation/reduction reaction continues and the Co deposit fills from the bottom of the via.

The process is substantially self-aligning in that the Co is deposited essentially only on the via bottom, such that the process is maskless because there is no need to mask areas other than the interconnect. Moreover, there is no need to subsequently remove substantial amounts of stray Co deposition from the dielectric.

The side walls of the vias have a dielectric surface in that they are defined by a bore in the bulk dielectric such as 12 in FIG. 1, and in that they are not seeded or catalyzed or treated with an electrically conducting material such as Pd, Co, or the like. In the sense that the method is performed without treating the via side walls, the via side walls comprise naked or bare dielectric surface.

In performing the invention, one of the criteria in selecting the electroless deposition composition is a desire to obtain a Co-based fill which has high conductivity. The desired conductivity is characterized by a resistivity which is, for example, preferably less than about 50 micro ohm-cm. This is in contrast to Co-based Cu-capping applications, where resistivity on the order of 60 to 80 micro ohm-cm is acceptable. With one approach, the desired conductivity is achieved by selection of bath chemistry to deposit a Co-based fill which is on the order of at least about 90 atomic % Co. To the extent the Co-based fill is diluted by bath components such as B and/or P from the reducing agents, this reduces conductivity. Accordingly, a balance is struck between a high enough reducing agent concentration to achieve acceptable deposition rates, and a low enough reducing agent concentration to yield the desired Co concentration in the deposit. If a bath characterized by a relatively higher deposition rate is employed, and a resistivity greater than about 50 micro ohm-cm in the deposit results, the resistivity can be reduced to an acceptable level by heat treatment or post annealing.

The invention is further illustrated by the following working examples.

### EXAMPLES 1-12

Within the above guidelines, electroless baths having the following compositions were prepared for self-initiated Co deposition:

### EXAMPLE 1

### Co—B—P Interconnect

CoCl₂ 6H₂O25 g/L

Citric acid 50 g/L

NH₄Cl15 g/L

DMAB9 g/L

Ammonium hypophosphite 26 g/L

This bath was prepared at room temperature. The components were added according to the following steps:

1. Preparation of Solution A:
a. Dissolve 25 g of CoCl₂ 6H₂O in less than 0.5 L of water.
b. Add 50 g of citric acid to complex Co²⁺ ions.
c. Add TMAH to adjust solution pH.
d. Finalize volume to 0.5 L.
e. Filter to remove any metal residues.

2. Preparation of Solution B:
a. Dissolve 26 g of ammonium hypophosphite in less than 0.5 L of water.
b. Dissolve 15 g of NH₄Cl
c. Add TMAH to neutralize solution pH.
d. Dissolve 9 g DMAB
e. Add TMAH to adjust solution pH.
f. Finalize volume to 0.5 L.
g. Filter.

3. Combine Solution A and Solution B and dilute to make 1 L.

4. Filter to remove any solids.

Baths were prepared according to the following lists of components to achieve other Co alloys. In each example, the bath was prepared according to the procedure outlined above, with the additional step of adding buffer (e.g., boric acid) as indicated to solutions A and B.

### EXAMPLE 2

### Co—B—P Interconnect

CoCl₂ 6H₂O43 g/L

Citric acid 43 g/L

Boric acid 14 g/L

DMAB9 g/L

Ammonium hypophosphite 26 g/L

### EXAMPLE 3

### Co—B—P Interconnect

CoCl₂ 6H₂O21 g/L

Malic acid 64 g/L

Boric acid 14 g/L

DMAB16 g/L

Hypophosphorous acid 26 g/L

### EXAMPLE 4

### Co—W—B—P Interconnect

CoCl₂ 6H₂O22 g/L

Citric acid 22 g/L

Boric acid 8 g/L

Tungstic acid 4 g/L

DMAB3 g/L

Hypophosphorous acid 23 g/L

### EXAMPLE 5

### Co—W—B—P Interconnect

CoCl₂ 6H₂O45 g/L

Citric acid 45 g/L

Boric acid 15 g/L

Tungstic acid 4 g/L

DMAB 3 g/L

Ammonium hypophosphite 23 g/L

### EXAMPLE 6

### Co—W—B—P Interconnect

CoCl₂ 6H₂O45 g/L

Citric acid 45 g/L

Boric acid 15 g/L

Tungstic acid 4 g/L

DMAB 9 g/L

Hypophosphorous acid 26 g/L

### EXAMPLE 7

### Co—B Interconnect

CoCl₂ 6H₂O25 g/L

Citric acid 70 g/L

NH₄Cl45 g/L

DMAB10 g/L

### EXAMPLE 8

### Co—B Interconnect

COSO₄ 7H₂O29 g/L

Citric acid 76 g/L

NH₄Cl48 g/L

DMAB5 g/L

### EXAMPLE 9

### Co—W—B Interconnect

CoCl₂ 6H₂O30 g/L

Citric acid 25 g/L

Boric acid 10 g/L

Tungstic acid 1 g/L

DMAB 2 g/L

### EXAMPLE 10

### Co—W—B Interconnect

CoCl₂ 6H₂O23 g/L

Citric acid 45 g/L

NH₄Cl15 g/L

Tungstic acid 4 g/L

DMAB 9 g/L

### EXAMPLE 11

### CO—W—B—P Interconnect

Co(OH) 25 g/L

Citric Acid 20 g/L

NH₄Cl2 g/L

Tungstic acid 0.4 g/L

DMAB 0.6 g/L

Hypophosphorous Acid 6 g/L

### EXAMPLE 12

### Co—W—B—P Interconnect

Co(OH)₂3 g/L

Citric Acid 20 g/L

Pyrophosphorous Acid 10 g/L

Tungstic acid 0.4 g/L

Boric Acid 5 g/L

DMAB 0.4 g/L

Hypophosphorous Acid 4 g/L

### EXAMPLE 13

According to the invention, interconnect substrates comprising a W bottom and SiO₂ side walls were pre-cleaned to remove tungsten oxide from the conductive surface of the via interconnect feature using 5% TMAH.

The substrate was then rinsed and immersed in the Co alloy electroless bath at a temperature of 60-95° C. for 10 minutes to 2 hours. Filling occurred at an approximate rate of about 100 Angstroms/minute up to about 3000 angstroms/minute. The filled via was free of voids.

### EXAMPLE 14

With reference to the following table, several substrates were filled with different Co alloys. For each fill, the alloy composition and approximate fill rate are shown. The alloy resistivity was between about 26 and about 80 micro ohm-cm.

| | Concentration, at. % | | | | Deposition Rate, |
|---|---|---|---|---|---|
| Film | Co | W | P | B | Angstroms/min |
| CoBP | 86-92 | | 4-12 | 1-5 | 100 to 3000 |
| CoWB | 50-90 | 5-30 | | 1-6 | 100 to 2000 |
| CoB | 95-99 | | | 0.5-4 | 300 to 1000 |
| CoWBP | 83-95 | 1-6 | 1-10 | 1-3 | 100 to 3000 |

Examples 5 through 8, 11, and 12 yielded acceptable resistivity of about 50 micro ohm-cm or less. Examples 2, 4, 5, and 6 had an acceptable deposition rate because of their relatively higher Co content as compared to examples 9, 11, and 12; and because of their relatively low concentration of complexing agent to metal ratio and high concentration of reducing agent.

### EXAMPLE 15

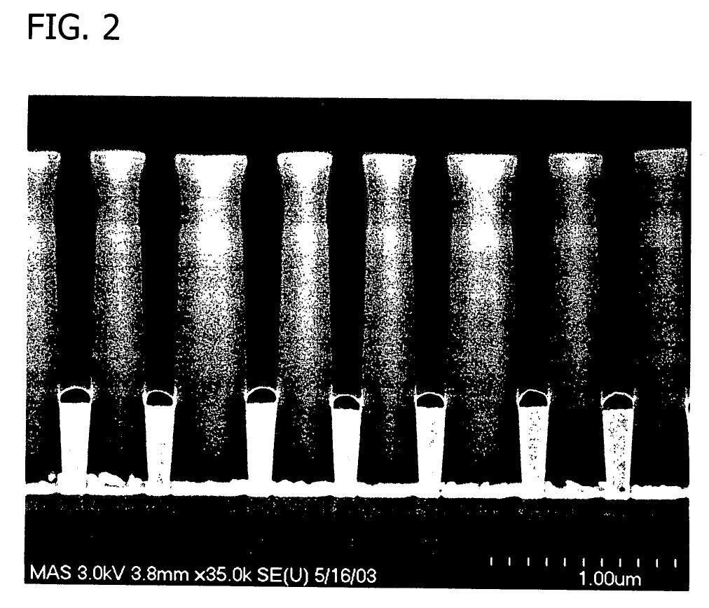

An interconnect substrate was immersed in the electroless bath of Example 6 at a pH of 9.8 and a temperature of 75° C. for 10 minutes. FIG. 2 is an SEM photograph taken of the Co alloy-filled via at a magnification of 35,000×. The photograph indicates uniform initiation and filling of the high aspect ratio via by the Co alloy, such that the Co alloy is dense and there are no voids within the interconnect feature. Side wall etching was minimized.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. For example, that the foregoing description and following claims refer to “an” interconnect means that there are one or more such interconnects. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A method for electrolessly filling a stacked memory cell interconnect feature, the method comprising:
contacting the stacked memory cell interconnect feature with an electroless deposition composition comprising a source of Co ions and a reducing agent, wherein the stacked memory interconnect feature has an electrically conducting bottom, side walls having a dielectric surface, and a height-to-width aspect ratio of at least about 2, whereby a portion of the Co ions are reduced to Co metal on the electrically conducting bottom, and bottom-up filling of the stacked memory interconnect feature is achieved by continued reduction of Co ions.

2. The method of claim 1 wherein the reducing agent comprises a borane-based reducing agent component.

3. The method of claim 2 wherein the borane-based reducing agent component is selected from the group consisting of an alkali metal borohydride, dimethylamine borane, diethylamine borane, morpholine borane, and mixtures thereof.

4. The method of claim 2 wherein the reducing agent further comprises a hypophosphite reducing agent component.

5. The method of claim 4 wherein the hypophosphite reducing agent component is selected from the group consisting of an alkali metal hypophosphite, ammonium hypophosphite, hypophosphorous acid, and mixtures thereof.

6. The method of claim 3 wherein the reducing agent further comprises a hypophosphite reducing agent component.

7. The method of claim 6 wherein the hypophosphite reducing agent component is selected from the group consisting of an alkali metal hypophosphite, ammonium hypophosphite, hypophosphorous acid, and mixtures thereof.

8. The method of claim 6 wherein the borane-based reducing agent component is present in a borane-based reducing agent component concentration, and the hypophosphite reducing agent component is present in a hypophosphite reducing agent component concentration, and the borane-based reducing agent component concentration and the hypophosphite reducing agent component concentration are selected to yield a concentration ratio of borane-based reducing agent component concentration in g/L to hypophosphite reducing agent component concentration in g/L which is less than about 0.5 at initial contact of the interconnect feature with the electroless deposition composition.

9. The method of claim 6 wherein the borane-based reducing agent component is present in a borane-based reducing agent component concentration, and the hypophosphite reducing agent component is present in a hypophosphite reducing agent component concentration, and the borane-based reducing agent component concentration and the hypophosphite reducing agent component concentration are selected to yield a concentration ratio of borane-based reducing agent component concentration in g/L to hypophosphite reducing agent component concentration in g/L which is less than about 0.2 at initial contact of the interconnect feature with the electroless deposition composition.

10. The method of claim 8 wherein:
the borane-based reducing agent is selected from the group consisting of an alkali metal borohydride, dimethylamine borane, diethylamine borane, morpholine borane, and mixtures thereof; and
the hypophosphite reducing agent is selected from the group consisting of an alkali metal hypophosphite, ammonium hypophosphite, hypophosphorous acid, and mixtures thereof.

11. The method of claim 9 wherein:
the borane-based reducing agent is selected from the group consisting of an alkali metal borohydride, dimethylamine borane, diethylamine borane, morpholine borane, and mixtures thereof; and
the hypophosphite reducing agent is selected from the group consisting of an alkali metal hypophosphite, ammonium hypophosphite, hypophosphorous acid, and mixtures thereof.

12. The method of claim 1 wherein the bottom-up filling of the stacked memory interconnect feature yields a Co-based filled interconnect feature comprising at least about 90 atomic % Co.

13. The method of claim 1 wherein the bottom-up filling yields a Co-based filled interconnect feature having a resistivity of about 50 micro ohm-cm or less.

14. The method of claim 1 wherein the bottom-up filling of the stacked memory interconnect feature yields a Co-based filled interconnect feature comprising at least about 90 atomic % Co and having a resistivity of about 50 micro ohm-cm or less.

15. The method of claim 1 wherein the electroless deposition composition comprises:
water;
a source of Co ions;
a complexing agent;
a buffering agent;
a borane-based reducing agent component; and
a hypophosphite reducing agent component.

16. A method for electrolessly filling a stacked memory cell interconnect feature, the method comprising:
contacting the stacked memory cell interconnect feature with an electroless deposition composition comprising a source of Co ions and a reducing agent, wherein the stacked memory interconnect feature has an electrically conducting bottom, side walls having a dielectric surface, and a height-to-width aspect ratio of at least about 10, whereby a portion of the Co ions are reduced to Co metal on the electrically conducting bottom, and bottom-up filling of the stacked memory interconnect feature is achieved by continued reduction of Co ions, wherein the electroless deposition composition comprises:
water;
a source of Co ions;
a complexing agent;
a buffering agent;
a borane-based reducing agent component selected from the group consisting of an alkali metal borohydride, dimethylamine borane, diethylamine borane, morpholine borane, and mixtures thereof; and
a hypophosphite reducing agent component selected from the group consisting of an alkali metal hypophosphite, ammonium hypophosphite, hypophosphorous acid, and mixtures thereof; and
wherein the borane-based reducing agent component is present in a borane-based reducing agent component concentration, and the hypophosphite reducing agent component is present in a hypophosphite reducing agent component concentration, and the borane-based reducing agent component concentration and the hypophosphite reducing agent component concentration are selected to yield a concentration ratio of borane-based reducing agent component concentration in g/L to hypophosphite reducing agent component concentration in g/L which is less than about 0.5.

17. The method of claim 16 wherein:
the Co ions are present in a concentration between about 1 g/L and about 20 g/L;
the complexing agent is present in a concentration between about 20 g/L and about 80 g/L;
the buffering agent is present in a concentration between about 0 g/L and about 20 g/L;
the borane-based reducing agent component is present in a concentration between about 0.5 g/L and about 16 g/L; and
the hypophosphite reducing agent component is present in a concentration between about 20 g/L and about 32 g/L.

18. The method of claim 16 wherein the concentration ratio of borane-based reducing agent component concentration in g/L to hypophosphite reducing agent component concentration in g/L is less than about 0.2.

19. An electroless deposition composition for electrolessly depositing Co in a high aspect ratio stacked memory cell interconnect feature, the composition comprising:
water;
a source of Co ions;
a complexing agent;
a buffering agent;
a borane-based reducing agent component; and
a hypophosphite reducing agent component;
wherein the borane-based reducing agent component is selected from the group consisting of an alkali metal borohydride, dimethylamine borane, diethylamine borane, morpholine borane, and mixtures thereof;
wherein the hypophosphite reducing agent component is selected from the group consisting of an alkali metal hypophosphite, ammonium hypophosphite, hypophosphorous acid, and mixtures thereof; and
wherein the borane-based reducing agent component is present in a borane-based reducing agent component concentration, and the hypophosphite reducing agent component is present in a hypophosphite reducing agent component concentration, and the borane-based reducing agent component concentration and the hypophosphite reducing agent component concentration are selected to yield a concentration ratio of borane-based reducing agent component concentration in g/L to hypophosphite reducing agent component concentration in g/L which is less than about 0.5.

20. The electroless deposition composition of claim 19 wherein:
the Co ions are present in a concentration between about 1 g/L and about 20 g/L;
the complexing agent is present in a concentration between about 20 g/L and about 80 g/L;
the buffering agent is present in a concentration between about 0 g/L and about 20 g/L;
the borane-based reducing agent component is present in a concentration between about 0.5 g/L and about 16 g/L; and
the hypophosphite reducing agent component is present in a concentration between about 20 g/L and about 32 g/L.

21. The electroless deposition composition of claim 19 wherein:
the concentration ratio of borane-based reducing agent component concentration in g/L to hypophosphite reducing agent component concentration in g/L is less than about 0.2.
